(19) United States
(12) Patent Application Publication
(10) Pub. No.: US 2003/0093298 A1
(43) Pub. Date: May 15, 2003

(54) System and method for providing secure remote access to patient files by authenticating personnel with biometric data

(76) Inventors: Javier Hernandez, Carrollton, TX (US); Greta Jean Black, Dallas, TX (US); Max Probasco, Richardson, TX (US)

Correspondence Address: HUGHES & LUCE LLP, 1717 MAIN STREET, SUITE 2800, DALLAS, TX, 75201, US

(21) Appl. No.: 10/269,303

(22) Filed: Oct. 11, 2002

Related U.S. Application Data
(60) Provisional application No. 60/329,170, filed on Oct. 12, 2001.

(51) Int. Cl. G06F 17/60; G06K 9/00; G06F 15/00; G06F 17/40

(52) U.S. Cl. 705/2; 702/187; 382/128

(57) ABSTRACT

One aspect of the present invention is a biometric module, comprising a serial adaptor that inserts into a personal digital assistant's series port, a serial port that accepts an a separate peripheral device's serial adaptor, a means for authenticating a user connected to the microprocessor, whereby the authentication means scans the user's biometric data, and a microprocessor connected to the serial adaptor, the serial port, and the authentication means, where the microprocessor regulates a data flow with the personal digital assistant. A different aspect of the present invention is a method to remotely authenticate a health care worker, the method comprising scanning the worker's biometric data into a PDA, scanning a patient's biometric data into a PDA, transmitting the patient's and worker's biometric data wirelessly from the PDA to a central location, and receiving authorization to access the patient's health care data wirelessly on a PDA from the central location.

### CROSS-REFERENCE TO RELATED APPLICATIONS

This application claims the benefit of and incorporates by reference U.S. Provisional Patent Application Serial No. 60/329,170 entitled “PDA BIOMETRIC MODULE AND METHOD THEREFORE” filed on Oct. 11, 2001.

### TECHNICAL FIELD OF THE INVENTION

The present invention relates generally to health care, and to providing a system and method for providing a secure access to patient files by accurately authenticating personnel using a remote, wireless, biometric device. More specifically, the present invention relates to providing a portable, wireless data capture and authentication system using a PDA within the system, which can be used generally to authenticate access to a secure area or file.

### BACKGROUND OF THE INVENTION

In today's home healthcare industry, compliance and fiscal management are keynotes for survival. Increased scrutiny by fiscal intermediaries, managed care entities, and federal auditors is mandating pre-emptive measures for accountability. According to the Office of Inspector General for Health and Human Services, eligibility is the number one priority of scrutiny in home health care. Most physicians are aware of the need to institute compliance programs as a safeguard against possible liability including prosecution and penalties. The ability to verify with a high degree of certainty the integrity and medical necessity of a plan of care is paramount to physicians in avoiding these issues of liability.

One solution has been to rely on highly repetitive and manpower intensive programs which rely on a great deal of review and redundancy. This option is not cost effective in terms of fiscal management for today's home health care providers.

Software is widely used in various industries to address these problems. The advent of decreasing bottom lines for home health care providers in order to remain economically viable while meeting regulatory mandates has highlighted the inability of current systems to effectively meet these diverse goals. As in any industry, management is responsible for ensuring regulatory compliance and fiscal viability. A simple mistake can impose a great liability on home health care providers and potentially result in the loss of government issued licenses to provide such care.

Due to these potential liabilities, it would be desirable to have a software package, which would assist in tracking and verifying the fiscal management and regulatory compliance issues associated with providing home health care. Such a system should assist in maintaining and ensuring document integrity, regulatory compliance, and provide for the non-repudiation of such documents and the health care providers responsible for these documents.

It would be desirable to have a system, which can maintain the integrity of health care data and related fiscal data. Furthermore, it would be desirable to have a software solution implemented by a networked information system, which authenticates and validates an individual user before allowing access to a database containing health care and related data. This access to the database should be carefully tracked to ensure that all access to the database is documented for when, where and by whom the database was accessed and whether data was added, reviewed, or edited.

Many businesses and people have certain confidential files. This confidentiality may be established because of an agreement the person has with another, or because of government regulations.

Restricting access to the files requires that a business properly authenticate each person requesting access. This ensures that only authorized people gain access to the information or secures location where the information is kept. While this may be easily accomplished when the information is maintained only within a secure facility, it becomes more difficult to restrict access to information when the information is portable or a person requires access to the information from off site and, therefore, requires portable and mobile authorization.

Physically restricted areas ensure that only authorized personnel gain physical access to the areas. Often, a database containing a list of authorized personnel or information concerning authorized personnel is checked against the person while attempting to access the information. While accessing databases in fixed secure facilities may be preferable, accessing these files remotely is difficult or impossible.

Some existing solutions take advantage of portable devices to record biometric data. However, these devices, to date, do not interact with a central database in real time. The ability to wirelessly or otherwise access this information remotely would give users desired access and portability. Additionally, many of the portable units are either dedicated biometric devices or unable to allow other units to attach thereto, thus making a single modular device.

Additionally, in the field of home health care, it is difficult to monitor some health care workers to ensure that they are properly monitoring patients. Because of privacy issues, patients' files are often restricted only to those with direct access or authorization to work with that patient. However, when the health care workers work remotely, at sites such as the patient's home, correct information is not available. Additionally, it is difficult for the worker to gain access to the necessary information remotely over the phone because of inabilities in verifying the worker's correct identity.

### SUMMARY OF THE INVENTION

The present invention provides a PDA biometric module that substantially eliminates or reduces disadvantages and problems associated with previously developed remote access and security systems and methods used to protect confidential information.

More specifically, the present invention provides a method of remotely authenticating an individual's access to information. This method first involves scanning the individual's biometric data. This data is then transmitted to a central location. The central location processes the biometric data to authorize access. Authorized individuals may then access the desired information.

Another embodiment of the present invention provides a biometric module that couples to a Personal Digital Assistant (PDA) via an adaptor. An adaptor such as a serial adaptor inserts into a PDA's data port, such as a serial port or any such port that accepts separate peripheral devices. A microprocessor executes code to authenticate an individual's access. To accomplish this, an individual's biometric data is scanned and compared to that data contained within a remote database. Once data and instructions within the database have been verified, the microprocessor regulates data flow to and from the personal digital assistant.

Another embodiment of the present invention teaches a method of transferring data from a biometric module. The biometric module connects to a PDA via a serial port, and scans biometric data into the module. This biometric data is transferred to a remote database for authentication.

One specific embodiment of the present invention remotely authenticates health care workers. First, a biometric module coupled to a PDA scans the worker's biometric data into the PDA. Next, the patient's biometric data is also scanned into the PDA. The patient's and worker's biometric data then transmit wirelessly from the PDA to a central location. The central location processes and sends authorization to access the patient's health care data wirelessly via a PDA.

The foregoing has outlined some of the objects that are more pertinent and features of the present invention. These objects should be construed to be merely illustrative of some of the features that are more prominent and applications of the invention. Many other beneficial results can be attained by applying the disclosed invention in a different manner or modifying the invention as will be described. Accordingly, other objects and a fuller understanding of the invention may be had by referring to the following Detailed Description of the Preferred Embodiment.

### BRIEF DESCRIPTION OF THE DRAWINGS

For a more complete understanding of the present invention and the advantages thereof, reference is now made to the following description taken in conjunction with the accompanying drawings in which like reference numerals indicate like features wherein:

FIG. 1 shows a schematic drawing of one aspect of the present invention;

FIG. 2 illustrates one embodiment of the present invention as a flow chart;

FIG. 3 illustrates one aspect of the present invention, from a front and back view, operating with a PDA;

FIG. 4 illustrates one aspect of the present invention, from a front and back view, operating with a different PDA;

FIG. 5 illustrates one aspect of the present invention, from a front and back view, operating with a different PDA and using the module's expansion slot;

FIG. 6 illustrates one aspect of the present invention, from a front and back view, operating with a PDA;

FIG. 7 illustrates one aspect of the present invention, from a front and back view, operating with a PDA;

FIG. 8 illustrates a front view of one aspect of the present invention used as a biometric scanning device;

FIG. 9 illustrates a back view of one aspect of the present invention used as a biometric scanning device;

FIGS. 10A-10D provides electrical drawings of one embodiment of the present invention; and

FIG. 11 illustrates with a flow chart form, one embodiment of the present invention.

### DETAILED DESCRIPTION OF THE INVENTION

Preferred embodiments of the present invention are illustrated in the FIGURES, like numerals being used to refer to like and corresponding parts of the various drawings.

The present invention provides a PDA biometric module that substantially eliminates or reduces disadvantages and problems associated with previously developed remote access and security systems and methods used to protect confidential information.

More specifically, the present invention provides a method of remotely authenticating an individual's access to information. This method first involves scanning the individual's biometric data. This data is then transmitted to a central location. The central location processes the biometric data to authorize access. Authorized individuals may then access the desired information.

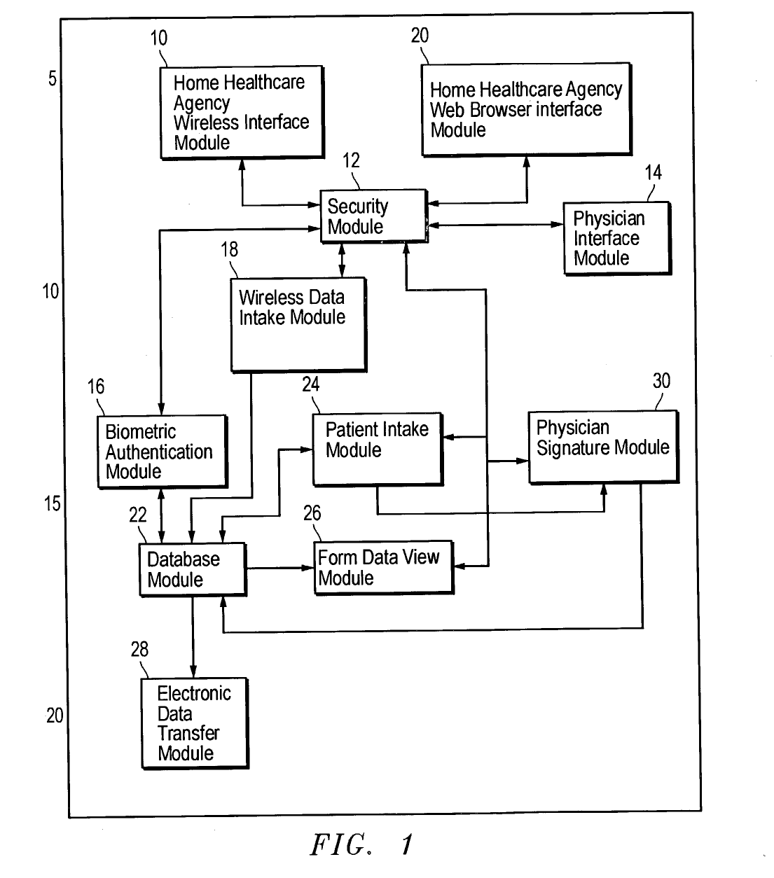

FIG. 1 provides a schematic drawing of one embodiment of the present invention. FIG. 1 shows one embodiment of the present invention that allows for operations of a home health care system. In FIG. 1, the Home Healthcare Agency (“HHA”) uses wireless module to interface with security module 12. Security Module 12 access rights to individual patient's file(s). Various other interfaces into the Security Module 12 are present and allow for system wide interaction with the module.

For example, when a physician desires to grant access to a specific healthcare worker, the physician sends this access information to a central server where the Security Module is located via Physician Interface Module 14, with this access information includes instructions to update the patient's access database in order to allow the healthcare worker to access the patient's files. Additionally, Security Module 12 interfaces with Biometric Authentication Module 16, wireless data intake module 18, and HHA Web Browser Interface Module 20. Database Module 22 interfaces with Biometric Authentication Module 16, Wireless Data Intake Module 18, and Patient Intake Module 24. Database Module 22 allows biometric information gathered on either an individual home health care worker and/or an individual patient before granting access rights to information contained within the database module. Physicians control and grant these access rights through patient intake module 24. Form Data View Module 26 formats data for presentation to an individual health care worker. The electronic Data Transfer Module 28 serves to transfer the patient's data to the home health care worker local computing device or PDA. Physician's Signature Module 30 allows physicians to electronically sign and approve care plans, the prescription of medications, and other like procedures.

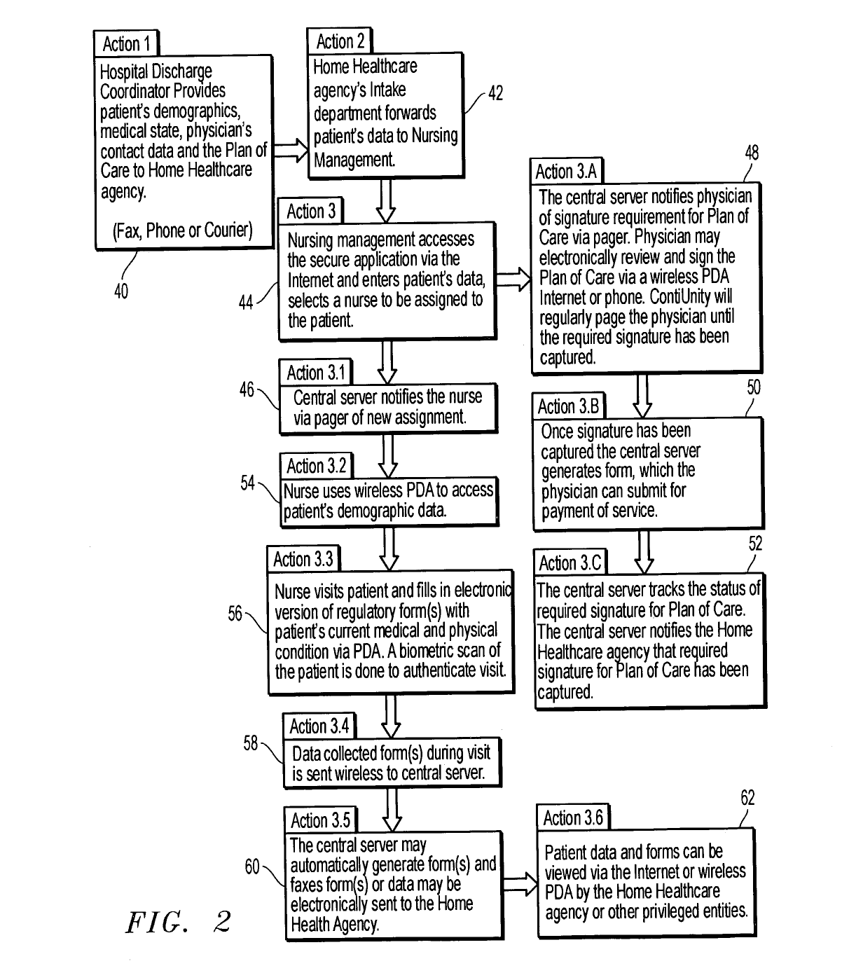

FIG. 2 illustrates one embodiment of the present invention as in flow chart. In the present invention, various user types include a super administrator, a HHA administrator and a caregiver. The present invention utilizes the super administrator design functionality. Typically, this functionality is assigned only to an authenticating entity. This aspect of the invention allows the super administrator to make system wide changes.

The super administrator may create a separate care provider domain for each HHA, which utilizes services from the operator of the services. Additionally, the present invention allows the super administrator to create, modify or delete a user in the care provider domain. The default user type of a created user is a caregiver. The super administrator can also assign the HHA administrator type to one or more users within a care provider domain.

The flow chart provided in FIGURE,2 describes the processes associated with one embodiment of the present invention. In step 40, a hospital discharge coordinator provides patient's demographics, medical state, physician's contact data and planned care to a home health care agency. This transfer of data may be accomplished via fax, phone, courier or other such method as known to those skilled in the art. In step 42, the HHA's intake department forwards the patient's data to nursing management. Nursing management accesses the care application via the Internet and enters patient's data and assigns a nurse to a patient in step 44. In step 46, a central server notifies a nurse or other health care worker of the new assignment. This notification may be via pager, e-mail, fax or telephone call from either an individual or a computer-generated voice or any other like method as known to those skilled in the art. Concurrently, the central server notifies a physician that the plan of care provided to the home health care agency in step 40 must be reviewed and approved. This approval may be documented with an electronic signature provided through the Physician's Signature Module 30 of FIG. 1. This may be accomplished via a wireless PDA, Internet, voice or other method wherein the signature, either real or electronic, is collected by Physician's Signature Module 30. This module allows the physician to electronically review and sign the patient care plan. The physician may be repeatedly prompted via page or other notifications until the plan of care has been reviewed and authorized. To assist a physician, the central server may generate required regulatory, accounting and administrative forms that document the actions taken by the physician, which can be submitted for payment of service. This feature, described in step 50, is accomplished in previous step 38. Once the plan of care has been reviewed and approved by the physician, the central server can notify the home health care agency that the plan of care has been approved for implementation in step 52.

A nurse or other home health care worker in step 54 will access patient's data via an internet connection, wireless PDA or other like information pathway known to those skilled in the art. This initial information will include the demographic information associated with the individual patient allowing the nurse to then actually visit the patient. This patient visit is accomplished in step 56, during which time the nurse or other home health care worker completes hard copy or electronic versions of regulatory, accounting and administrative forms which document the patient's current medical and physical condition. Electronic forms are completed via an electronic interface such as a PDA. The biometric scan of the patient and/or the nurse or home health care worker verifies and authenticates the visit. This data collected during the visit may be sent to a central server in step 58. This transmission may take place via a wireless connection or other connection known to those skilled in the art. The central server will then process the data collected from the home health care worker, or nurse, to generate the necessary forms and paperwork to properly document the home health care worker's visit and provide these forms, either electronically or in hard copy format, to the home health care agency.

In step 62, the patient data forms for the physicians or other health care workers may be made available via the internet or other data connection such as a wireless PDA of the HHA or any other privileged entity.

The present invention scales to allow the HHA administrator to create modify or delete a user within the HHA administrator's domain. The default user type given is a caregiver. The maximum number of users within a specific care provider domain can be set by the super administrator and the HHA administrator prior to commencing operations.

Users within the systems to are assigned unique User ID and password combination(s). These combinations are required to access the information via the Internet.

Additionally, various data fields relating to each user (a HHA administrator or caregiver) are stored within the database. This data includes but is not limited to the following:

(1) Name

(2) Office Telephone Number

(3) Home Telephone Number

(4) Cellular Telephone Number

(5) Pager Number

(6) Home Fax Number

(7) Office Fax Number

(8) Email address

(9) Care specialty

(10) Manager's Name

(11) User Name

(12) Temporary Password

The HHA Administrator completes the following steps. First, the HHA enters patient intake data and assigns a caregiver user to a specific patient. The HHA also reviews patient data and electronically fills out required regulatory forms during patient visit via wireless handheld device. In this review, if the Plan of Care for a patient has not been approved, the HHA requests Physician approval of the HHA. To ensure compliance, the HHA can view and modify completed regulatory forms via the Internet. Additionally, the HHA can request completed regulatory forms be sent to a specific destination via fax, email or other method known to those skilled in the art. HHA's can electronically notify caregivers of new patient assignment. HHA can specify and review options before the system automatically forwards collected patient data in the regulatory form to the HHA. Similarly, the HHA can specify a maximum allowable delay time for all caregivers within the HHA Administrator's domain before a completed form is automatically sent to the HHA.

Caregivers can electronically retrieve new patient assignment information and review assigned patient data. Next, caregivers electronically complete regulatory forms during their visit via a network computing or wireless handheld device. Additionally, caregivers can electronically view and modify a completed regulatory form via the Internet; request completed regulatory forms be sent to a specific destination via fax or email; specify review option before the system automatically forwards collected patient data in the regulatory form to the home healthcare agency; and specify a maximum allowable delay time before a completed form is automatically sent to the home healthcare agency.

In the present invention, a HHA administrator enters patient data for a new patient into the system that requires care from the HHA via the Add Patient Screen. The HHA enters various types of information such as but not limited to the patient's name, address, discharge date, primary care physician, date of birth, social security number, blood type, condition, and required care type.

The HHA administrator then assigns a caregiver to the patient by selecting the caregiver from a list of the HHA's caregivers. The HHA administrator tracks and requests approval of the PCO from the primary physician. This approval may be given if the physician electronically signs the PCO by checking a box in a box designated for such purpose. Once assigned by the HHA administrator, the selected caregiver is automatically notified of the new caregiver assignment. Notification caregiver can be sent to the caregiver's pager, cellular phone, email, fax, or a combination of such or other electronic devices.

The notification may repeat until the selected caregiver acknowledges the notification. The HHA administrator may specify the time intervals between these notifications during the patient intake phase. In one embodiment, notification code takes the form of a numeric code, which internally identifies the care provider domain, the caregiver, the patient and the required care.

(1) aaa-bbb-cccc-dddd

Domain Caregiver ID Patient ID Care

Once notified, the caregiver may acknowledge the notification by utilizing an acknowledge of notification application within the caregiver's wireless PDA. In order to acknowledge the notification, the caregiver enters the received notification code when prompted by the “acknowledge notification” application, provide the biometric data described below via the Biometric Module and press the “Acknowledge” button.

Once the “Acknowledge” button has been pressed, the PDA sends the acknowledgement wirelessly or otherwise to a secure central server, which records the acknowledgement. The server authenticates the notification code and the biometric data. Upon successful authentication, the server sends the patient's demographic data to the caregiver's wireless PDA. The caregiver uses the demographic data to travel to the patient's residence.

The caregiver may use the CU-Forms application present on a wireless PDA. The CU-Forms allow caregivers to electronically complete forms required for the visit with the patient. The caregiver next enters the notification code received for the patient on the CU-Forms screen and presses the “Next” button. Based on the notification code, the CU-Forms application then selects the correct form, which must be filled out during the visit.

Caregivers may be electronically prompted to answer questions related to the selected form during the course of the patient visit. When data entry has been completed, the patient and/or the healthcare provider will provide biometric data via the biometric module and the caregiver will press the Submit button. The PDA sends the collected data wireless or otherwise to the secure server.

When the server receives data resulting from a patient visit, the data is securely stored in the server's database. Based on the caregiver/HHA Administrator's specified configuration, the server will (1) automatically generate an electronic version of the regulatory form and forward it to the HHA via fax or email; (2) generate an electronic version of the regulatory form and wait for the caregiver to review and make modifications to the form via the Internet, and then forward the form to the HHA via fax or email; or (3) generate an electronic version of the regulatory form after the maximum allowable delay has expired and forward the form to the HHA via fax or email.

Based on selections made by the HHA Administrator at the patient intake or PCO screen, the central server may automatically generate an electronic request to the primary care physician via email, phone, pager or other known method for physician's approval as evidenced by their signature (electronic or otherwise) on the patient's PCO. The central server tracks the request for the physician's review and signature. Additionally, the central server may notify the HHA Administrator periodically of the status of the PCO via email or their web browser. Physician may electronically sign the PCO via a web browser, wireless PDA, telephone/cell phone, two-way pager, or other method as known to those skilled in the art.

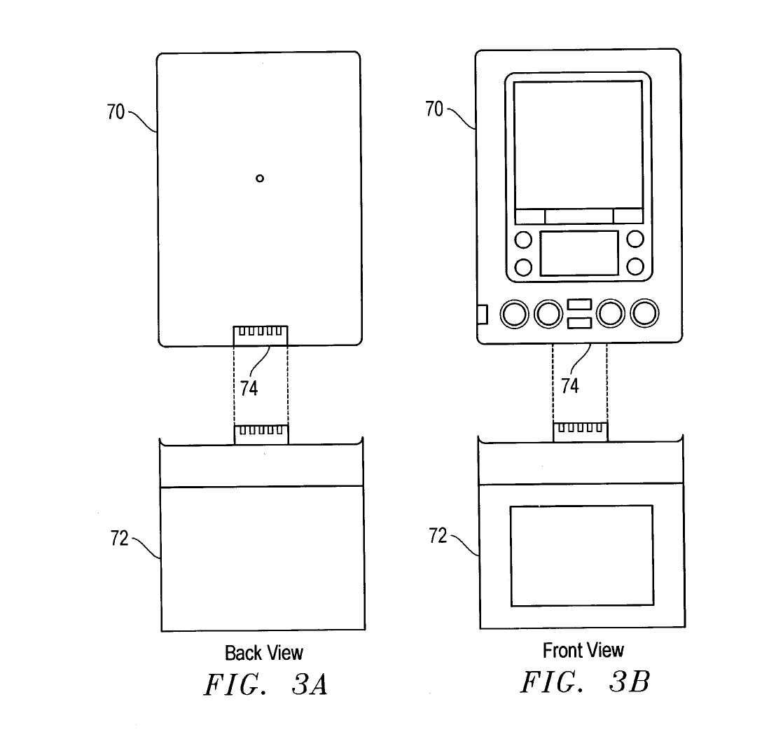

FIG. 3 illustrates one embodiment of the present invention, from a front and back view, operating with a PDA. In this embodiment, a wireless PDA 70 couples to a Biometric Authorization Module 72. This combined system provides the means by which to biometrically authorize access to patient files and to provide historical accounting of patient care. Furthermore other functionalities within the PDA may be unaffected depending on the PDA's configuration. This part of the present invention will work for any PDA. In the embodiment shown in FIG. 3, the PDA connects to Biometric Authorization Module 72 through serial port 74. The biometric scanner of FIG. 3 scans the thumb/fingers on an individual.

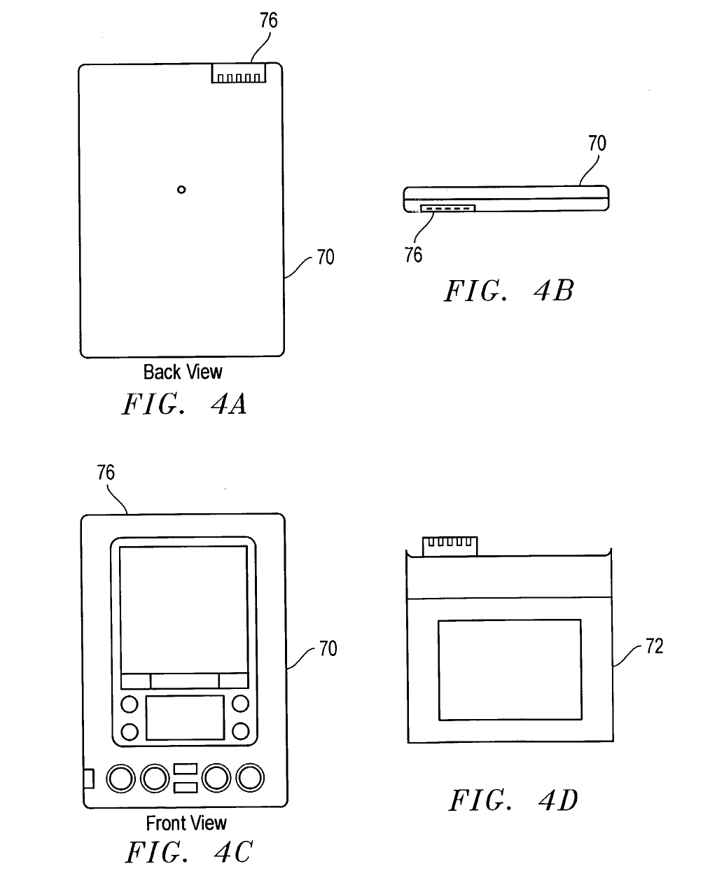

FIG. 4 illustrates another embodiment of the present invention, from a front and back view, operating with a next generation PDA. Here Biometric Authorization Module 72 couples to PDA 70 via an expansion slot 76. Here the biometric scanner as described in FIG. 3 scans the thumb/fingers with module 72.

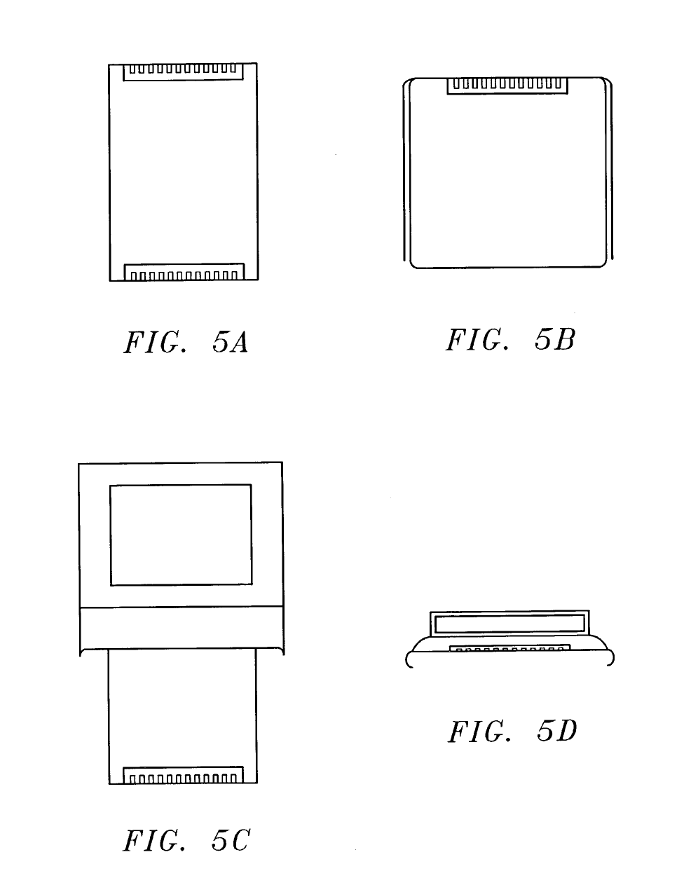

FIG. 5 illustrates yet another embodiment of the present invention, from a front and back view, operating with a different PDA. In this embodiment, an expansion slot within the Biometric Authorization Module 72 allows additional devices to be coupled to the combined PDA/biometric authorization module.

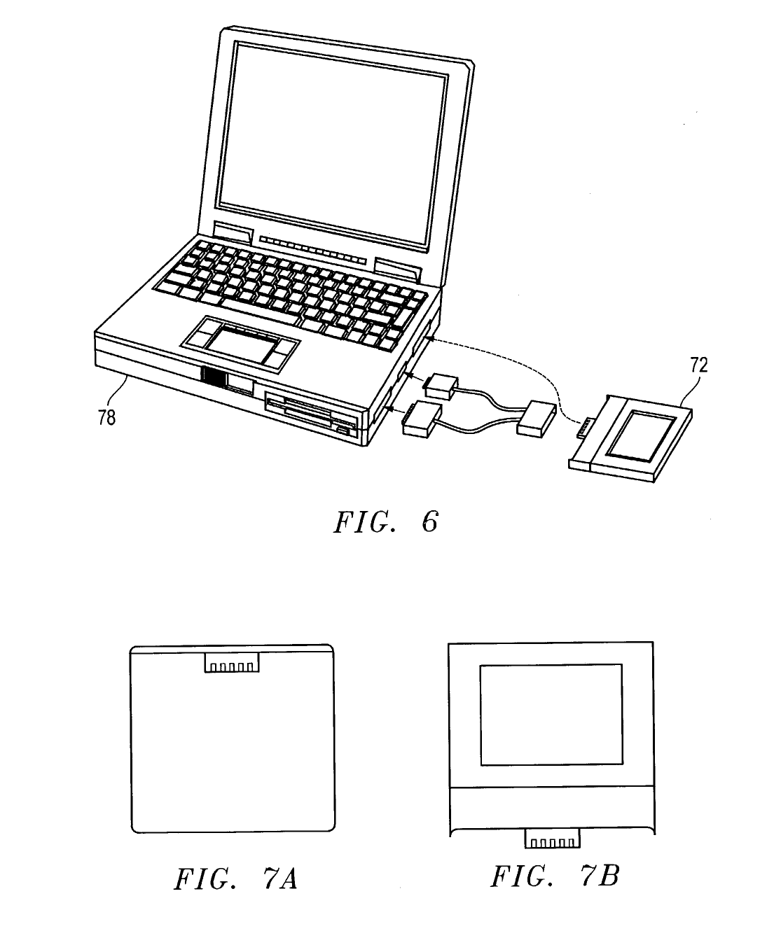

FIGS. 6 and 7 illustrate still yet another embodiment of the present invention, from a front and back view, wherein the biometric authorization module is designed to interface with a pocket PC 78 via a PC card slot 80, or computer Flash car 82, or Smart card port 84 or other like interface as known to those skilled in the art.

This biometric module attaches to the serial, expansion or any like port of any PDA or portable computing device that allows other ports to be connected to the modular unit. The main portion of the invention connects to the PDA device through its serial port. Using micro controllers within the biometric authorization module, the device regulates data flow between the modular unit and the computing device.

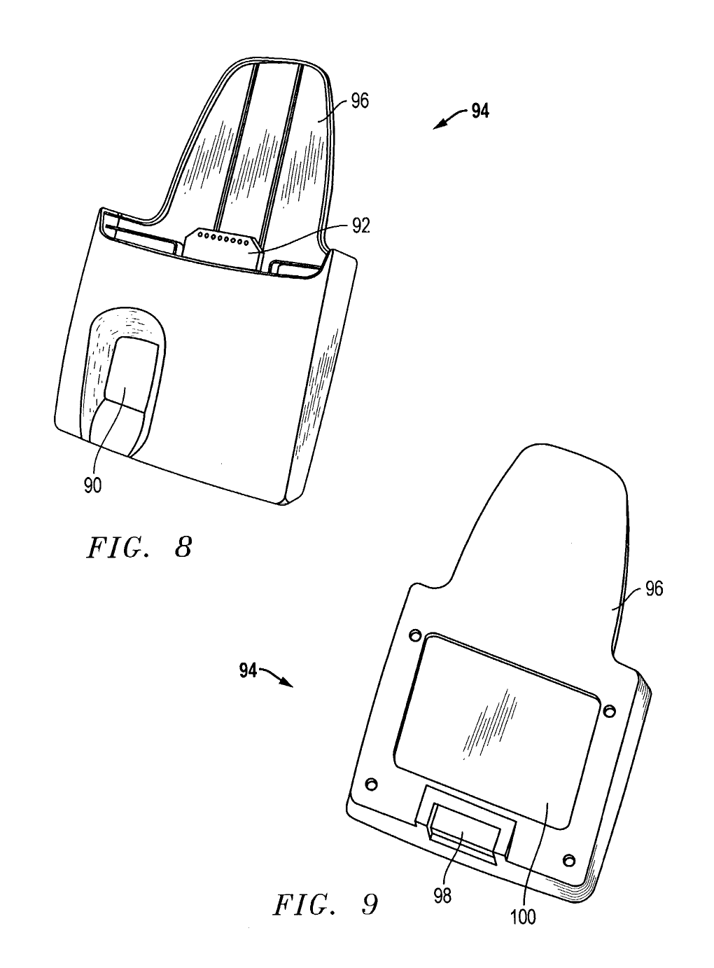

FIG. 8 illustrates a front view of one aspect of the present invention used as a biometric scanning device. FIG. 9 illustrates a back view of one aspect of the present invention used as a biometric scanning device. In FIG. 8, the module has a finger printing receiving area 90 that allows fingerprints to be taken. The biometric data is transferred to the PDA through port connections 92 when the PDA is attached to module 94. Backing unit 96 provides support to the PDA when connected to module 94 and aids in preventing the module from disconnecting from the PDA during their coupled use. An expansion slot may be incorporated into module 94 to allow other modules to be connected while module 94 is connected to the PDA.

FIG. 9 depicts the backside of FIG. 8. In FIG. 9, backing unit 96 is clearly shown. Expansion slot 98, which was not visible in FIG. 8, is now visible. Battery storage area 100 allows module 94 to utilize its own power source without draining the PDA's power supply.

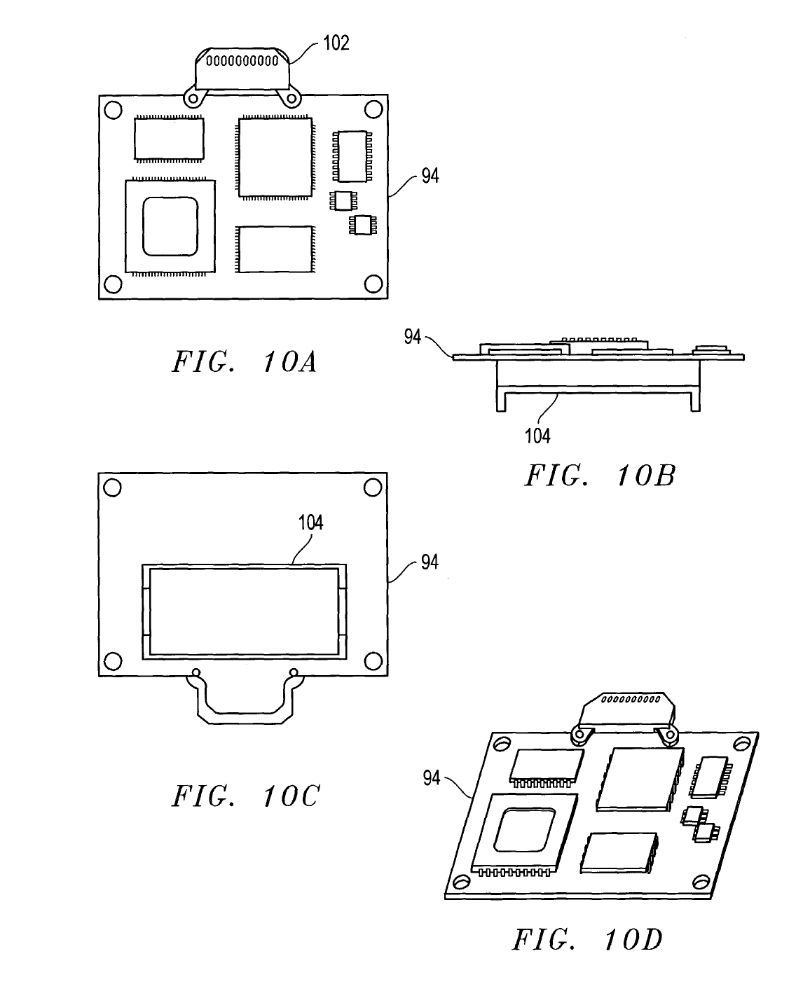

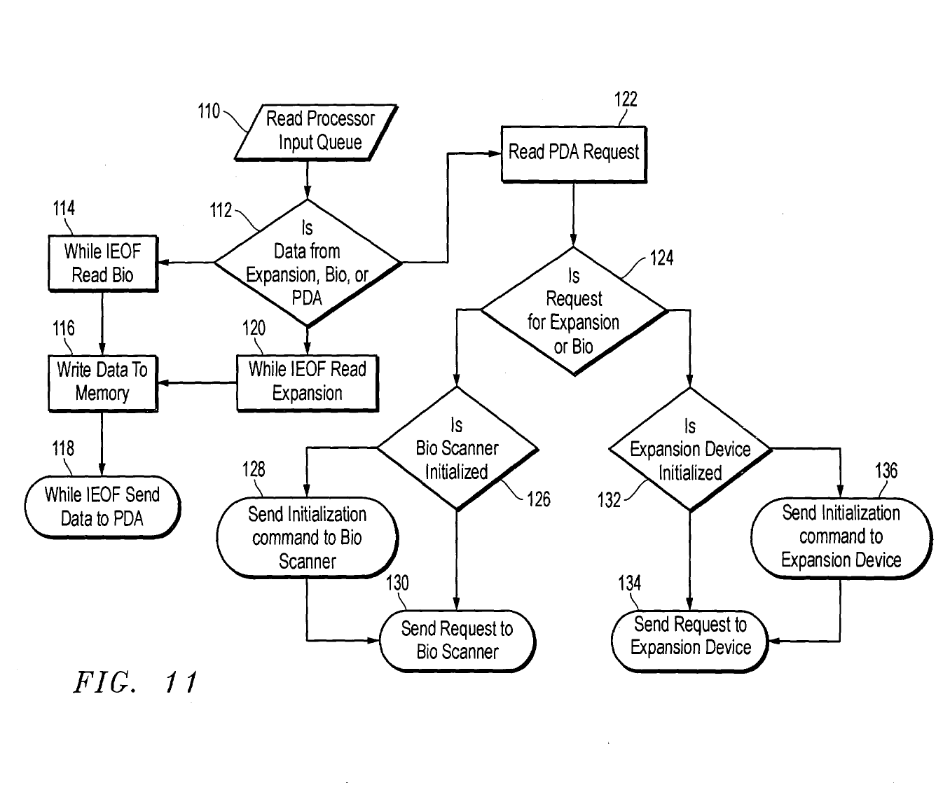

FIGS. 10A-10D provide plan and reference views of the interior components of biometric authorization module 94. This biometric authorization module 94 includes a data connector 102, which allows the components of module 94 to communicate with a PDA or other like device known to those skilled in the art. A solid state fingerprint sensor 104 or other like biometric measuring device allows biometric data, such as fingerprints, to be gathered from either an individual user or in the case of healthcare applications, a patient to be associated with data collected and entered via the coupled PDA or computing device. Additionally, biometric authorization module 94 may allow additional units to be attached to extra ports located with module 94. The modular unit allows additional modular units to be attached to an extra serial connection located on it.

In this manner, other modular units with different functionalities can be attached to the PDA in a “daisy chain”. The microprocessor within each unit controls the data flow across and through that unit, thereby allowing the daisy chained modules to communicate with each other and with the PDA as necessary, greatly increasing the functionality of the PDA.

The Flow chart provided as FIG. 11 illustrates the methodology used by the microprocessor to control data flow. Here the microprocessor has an input queue 110 for data requests and transfers. The microprocessor reads from the queue. At decision point 112 the microprocessor determines whether the data originated from the PDA, the module itself, or from the expansion slot.

If the data flow is from the module, the microprocessor reads the data until an end of file signal is read in step 114. The microprocessor writes the data to the module's memory in step 116. Once the serial port is clear, the microprocessor sends the data to the PDA via the serial port in step 118.

If the data flow originated from the expansion slot, the module reads the data flow from the expansion slot until it receives an end of file signal in step 120. The microprocessor writes the data from the expansion slot in to the module's memory in step 116, whereupon, it sends the data to the PDA once the serial port is clear in step 118. It is important to note that the invention can be arranged so that the microprocessor is reading data from the expansion slot while sending different data to the PDA. In this way, the module multitasks and enhances data flow from the expansion slot while processing to the PDA.

If the data flow is from the PDA, the module reads the PDA request in step 122 and determines at decision point 124 whether the request is for the module or for the expansion slot. If the request is for the module, in this example, a bio scanner, the microprocessor determines whether the system components are initialized at decision point 126. If the system components are not initialized then, an initialization command is sent to the system components in step 128. Upon initialization, the PDA request is sent to the system components in step 130. If the components are found to be initialized then the request is sent directly to the system components in step 130.

If the request is for a device connected to the expansion slot, then the module determines whether a module is connected to the expansion slot that is capable of receiving the data, but determining whether the expansion device is initialized in step 132. If it is active and ready to receive the data flow, the module sends the data through the expansion slot to the peripheral device connected to the expansion slot in step 134. If it is not ready to receive the data, the microprocessor attempts to send an initialization command to the peripheral device through the expansion slot in step 136. If a successful initialization occurs then the data is sent to the device through the expansion slot in step 134.

Data transfer between the daisy-chained modules can be accomplished in a variety of methods. The preferred embodiment is that as the data reaches a module, the microprocessor makes a determination as to whether the data or instruction set is intended for that module's system components. If it is not for that module, then the module forwards the data to the next module in the daisy chain until it reaches the appropriate peripheral device.

The present invention also allows the modules to have unique addresses so that data transferred between the module and the PDA will have the unique address associated with it. In this embodiment, as the data or instruction set reaches the microprocessor on a module, the microprocessor will either forward it onto that module's system components or forward it onto the next module depending on the unique address.

Therefore, one aspect of the present invention is a biometric module, comprising a serial adaptor that inserts into a personal digital assistant's series port, a serial port that accepts a separate peripheral device's serial adaptor, a means for authenticating a user connected to the microprocessor, whereby the authentication means scans the user's biometric data, and a microprocessor connected to the serial adaptor, the serial port, and the authentication means, where the microprocessor regulates a data flow with the personal digital assistant.

Another aspect of the present invention is a method to transfer data from a biometric module, where the method comprises connecting the module to the PDA via a serial port, scanning biometric data into the module, and transferring the biometric data to the PDA via the serial port.

A different aspect of the present invention is a method to remotely authenticate a health care worker, the method comprising scanning the worker's biometric data into a PDA, scanning a patient's biometric data into a PDA, transmitting the patient's and worker's biometric data wirelessly from the PDA to a central location, and receiving authorization to access the patient's health care data wirelessly on a PDA from the central location.

In summary, the present invention provides a PDA biometric module that substantially eliminates or reduces disadvantages and problems associated with previously developed remote access and security systems and methods used to protect confidential information. More specifically, the present invention provides a method of remotely authenticating an individual's access to information. This method first involves scanning the individual's biometric data. This data is then transmitted to a central location. The central location processes the biometric data to authorize access. Authorized individuals may then access the desired information.

One embodiment of the present invention provides a method for providing security to health care information systems. This method involves first compiling within a database, biometric data relating to a set of users user wherein said biometric data is unique to an individual user. A connection is made between a user and the information system. This connection is terminated if the user's identity cannot be verified. This verification is accomplished by inputting biometric data unique to a user into a user interface associated with the information system and validating the biometric data unique to the user with the database. Once the verification is complete, health care or other required data relating to the patient is exchanged between the information system and user. New information supplied by the user may be remotely stored in a memory location accessible by the information system. This process may be repeated as necessary when additional health care data is to be added to or reviewed from the information system by users.

This biometric data reviewed may include fingerprint information, or other like data known to those skilled in the art, collected by a biometric authentication module coupled to a networked computing device. The database may relate biometric data to a name of said user and a DEA or employee number assigned to said user.

Additionally, users, health care workers, may be assigned varying privileges wherein the privileges may be assigned by a physician or other health care supervisor and wherein the privileges determine what data within the information system each user has access to provide or review. Furthermore, these user privileges may be specific to individual patients.

In yet another embodiment the present invention is executed within an information system that contains remote computing devices such as PDAs or other like devices networked to a central computing system via a secure communication pathway.

The present invention provides a significant advantage in that health care data provided from users to the information system receives a date/time stamp for each access attempt to the health care data. Further, the present invention allows the creation of a non-reputable audit trail establishing when, where and by whom all data was provided to or reviewed from the information system.

In yet another embodiment, the present inventoin allows the creation of a health care information system. This system includes remote computing devices operable to provide or/receive health care data from a set of health care providers. Access to this data is keyed by a biometric scanning module operable to scan biometric data unique to each health care provider or patient. This data is provided by the remote computing device to a host computer system operable to store healthcare data for future review by health care providers. This host computer system executes a software engine on a processor and is coupled to a storage device operable to store said health care data. This processor couples to the storage device such that the health care information system is directed by said software engine to securely receive and store health care date for future review. Specifically the processor directs the validation of individual health care provider access to the health care information system and the reception/transmission of health care data from the health care information system to individual health care provider after validating said individual health care provider's access to the health care information system. This communication occurs over a secure communication pathway between remote computing devices and the host computer system. These remote computing devices may include wireless personal digital assistant.

Although the present invention is described in detail, it should be understood that various changes, substitutions and alterations can be made hereto without departing from the spirit and scope of the invention as described by the appended claims.

What is claimed:

1. A method for providing security to health care information systems, comprising the steps of:
compiling within a database, biometric data relating to a set of users user wherein said biometric data is unique to an individual user;
establishing a connection between a user and the information system;
terminating said connection if said user's identity cannot be verified;
providing health care data from said user to the information system or from the information system to said user;
storing said health care data in a memory location accessible by the information system;
disconnecting said first user from the information system; and
repeating the above steps as necessary when additional health care data is to be added to or reviewed from the information system by said set of users.

2. The method of claim 1, wherein said biometric data comprises fingerprint information collected by a biometric authentication module coupled to a networked computing device.

3. The method of claim 2, wherein said database relates biometric data to a name of said user and a DEA or employee number assigned to said user.

4. The method of claim 3, wherein identity of said set of users is verified by:
inputting biometric data unique to said user into a user interface associated with the information system; and
validating said biometric data unique to said user with said database.

5. The method claim 1, further comprising the steps of: assigning privileges to each user of said set of user wherein said privileges determine what data within the information system each user has access to provide or review.

6. The method of claim 5, wherein said privileges of said users are specific to individual patients.

7. The method of claim 1, wherein the information system comprises:
at least one remote computing device;
at least one central computing system; and
a secure communication pathway between said at least one remote workstation and said at least one host computer system.

8. The method of claim 1, wherein health care data provided from said set of users to the information system receives a date/time stamp for each access attempt to said health care data.

9. The method of claim 1, further comprising the step of creating an non-reputable audit trail establishing when, where and by whom all data was provided to or reviewed from the information system.

10. A method for providing security to health care information systems, comprising the steps of:
compiling within a database, biometric data relating to a set of users user wherein said biometric data is unique to an individual user, and wherein said biometric data comprises fingerprint information collected by a biometric authentication module coupled to a networked computing device, and wherein said database relates biometric data to a name of said user and a DEA or employee number assigned to said user;
establishing a connection between a user and the information system;
terminating said connection if said user's identity cannot be verified;
providing health care data from said user to the information system or from the information system to said user;
storing said health care data in a memory location accessible by the information system;
disconnecting said first user from the information system; and
repeating the above steps as necessary when additional health care data is to be added to or reviewed from the information system by said set of users.

11. The method of claim 10, wherein identity of said set of users is verified by:
inputting biometric data unique to said user into a user interface associated with the information system; and
validating said biometric data unique to said user with said database.

12. The method claim 10, further comprising the steps of:
assigning privileges to each user of said set of user wherein said privileges determine what data within the information system each user has access to provide or review.

13. The method of claim 12, wherein said privileges of said users are specific to individual patients.

14. The method of claim 10, wherein the information system comprises:
at least one remote computing device;
at least one central computing system; and
a secure communication pathway between said at least one remote workstation and said at least one host computer system.

15. The method of claim 10, wherein health care data provided from said set of users to the information system receives a date/time stamp to be permanently associated with said health care data.

16. The method of claim 10, further comprising the steps of:
creating an non-reputable audit trail establishing when, where and by whom all data was provided to or reviewed from the information system.

17. A health care information system comprising:
at least one remote computing device operable to provide or receive health care data from a set of health care providers;
a biometric scanning module operable to scan biometric data unique to each health care provider;
at least one host computer system operable to store said healthcare data for future review by said set of health care providers, said host computer system comprising:
a software engine;
a storage device operable to store said health care data;
a memory operable to store said software engine; a processor coupled to said storage device and said memory, said processor operable to execute said software engine such that the health care information system is directed by said software engine to securely receive and store health care date for future review by performing the steps of:
validating individual health care provider access to the health care information system; and
receiving or providing said health care data from the health care information system to said individual health care provider after validating said individual health care provider's access to the health care information system; and
a secure communication pathway between said at least one remote workstation and said at least one host computer system.

18. The health care information system of claim 17, wherein said at least one remote computing device comprises a wireless personal digital assistant.

19. The health care information system of claim 17, wherein said step of validating individual health care provider access to the health care information system further comprises:
inputting said individual health care provider and a unique biometric data into a user interface provided by said software engine at said remote computing device;
validating said unique biometric data with data contained within said at least one host computer system.

20. The system of claim 19, wherein said software engine is further operable to assign privileges to each individual health care provider of said set of individual health care provider wherein said privileges determine what data within the information system each individual health care provider has access to provide or review.

21. The system of claim 20, wherein said privileges of said individual health care providers are specific to individual patients.

22. The system of claim 17, wherein said software engine is further operable to assign a date/time stamp to each access attempt to said health care data provided by said individual health care providers.

23. The system of claim 22, wherein said software engine is further operable to create a non-reputable audit trail establishing when, where and by whom all data was provided to or reviewed from the information system.
